(19) United States
(12) Patent Application Publication
(10) Pub. No.: US 2026/0094407 A1
(43) Pub. Date: Apr. 2, 2026

(54) Two-Dimensional LiDAR-Based Method for Extracting Environmental Rectangular Point Coordinate Angle

(71) Applicant: Zhejiang Kecong Control Technology Co., Ltd., Hangzhou (CN)

(72) Inventors: Jian Chen, Hangzhou (CN); Wenyao Pang, Hangzhou (CN); Weiting Xu, Hangzhou (CN); Wenwei Wang, Hangzhou (CN)

(21) Appl. No.: 19/111,617

(22) PCT Filed: Dec. 26, 2022
(86) PCT No.: PCT/CN2022/141745

§ 371 Date: Mar. 13, 2025

(30) Foreign Application Priority Data
Sep. 13, 2022 (CN) 202211118952.4

(51) Int. Cl. G06V 10/44; G01S 17/89; G06T 7/60

(52) U.S. Cl. CPC G06V 10/44; G01S 17/89; G06T 7/60; G06T 11/23; G06T 2207/20076

(57) ABSTRACT

A method for extracting coordinates and angle of environmental rectangular points based on two-dimensional lidar: Traverse laser dots in the natural environment point cloud frame scanned by laser; select the neighborhood dot set of a random dot Pk, calculate the mean value of angles between lines from Pk to other dots and the X-axis of the laser coordinate system as the segmentation line; divide into left and right dot sets and extract inner dots; fit straight lines, and take their intersection as a rectangular point when the included angle is close to 90°; draw half-lines with the rectangular point as the vertex to determine the angle. This method can extract coordinates and angles of building rectangular points.

### BACKGROUND OF THE INVENTION

### Technical Field

The invention relates to the technical field of data processing, in particular to a method for extracting the coordinates and angle of an environmental rectangular point based on two-dimensional lidar.

### Description of Related Art

With the development of self-driving and low-speed mobile robots, the simultaneous localization and mapping (slam) technique based on natural features observed by two-dimensional laser is applied more and more widely. There are two types of slam: slam based on sparse feature points, and slam based on dense point clouds. For the former, stable feature points in the environment need to be extracted for real-time localization and map updating. For the latter, feature points in the environment need to be extracted to set an accurate initial value during loop matching.

### BRIEF SUMMARY OF THE INVENTION

Focusing on the accuracy of loop matching of slam, the invention provides a method for extracting the coordinates and angle of an environmental rectangular point based on two-dimensional lidar, which acquires information of a rectangular point, including not only the planar xy coordinates, but also the angle theta of the rectangular point, thereby improving the accuracy of loop matching.

The invention adopts the following technical solution:

A method for extracting the coordinates and angle of an environmental rectangular point based on two-dimensional lidar includes: S100: traversing laser dots in a natural environment point cloud frame scanned by a two-dimensional laser; S200: selecting dot sets dots near in a neighborhood of a random dot Pk, calculating angles between lines from Pk as a starting dot to all other dots in dots near and an x axis of a laser coordinate system, solving a mean value of all the angles, and using the mean value as an angle segmentation line of dots near; S300: separating dot sets dots left and dots right on left and right sides of dots near according to the angle segmentation line, and extracting, from dots left and dots right, inner dots inner left and inner right each having a variance less than a threshold by means of a straight line-based random sample consensus algorithm; S400: fitting line left and line right according to the inner dots inner left and inner right by a straight line fitting method, solving an included angle between the two straight lines, and when the included angle is close to 90°, determining an intersection of the two straight lines as a rectangular point; and S500, drawing two half-lines coinciding with line left and line right with the rectangular point as a vertex, and determining an angle of the rectangular point with one of the half-lines as a reference.

Preferably, in S500, the two half-lines are set as X₁ and Y₁ axes according to a right-hand rule, wherein an included angle between the X₁ axis and the X axis as the angle of the rectangular point.

Preferably, in S200, the dot Pk is selected every five laser dots.

Preferably, the number of the dot sets dots near is greater than 20 and the number of the dot sets dots left and the number of the dot sets dots right are greater than 10; otherwise, the random dot Pk is reselected.

Preferably, the neighborhood has a diameter of 0.5 m.

Preferably, in S400, when the included angle is between 80° and 100°, the intersection of the two straight lines is determined as the rectangular point.

Preferably, S500 further includes: with the rectangular point as a center, respectively solving all-quadrant angles of the half-lines on two sides, and using an included angle between one of the half-lines and the X axis as the angle of the rectangular point.

Preferably, the method for extracting the coordinates and angle of an environmental rectangular point based on two-dimensional lidar further includes: S600: saving the rectangular point in a vector vector corner; and if a distance and angle difference between a subsequent rectangular point Pm and any point in vector corner are within a threshold, determining the subsequent rectangular point Pm and the rectangular point as a same point, and skipping saving Pm in vector corner.

Compared with the prior art, the invention has the following advantages:

According to the method for extracting the coordinates and angle of an environmental rectangular point based on two-dimensional lidar, acquired rectangular points are used as feature points for loop matching, and dot sets on left and right sides of an angle segmentation line are fitted to obtain to two straight lines to determine whether a point is a rectangular point, two half-lines are drawn with the rectangular point as a vertex, the angle of the rectangular point is determined with one of the half-lines as a reference, and the rectangular point is determined according to the planar coordinates and angle, such that the accuracy of loop matching is improved.

### BRIEF DESCRIPTION OF THE SEVERAL VIEWS OF THE DRAWINGS

FIG. 1 is a flow diagram according to the invention.

FIG. 2 is a schematic diagram of a determination result of a rectangular point.

### DETAILED DESCRIPTION OF THE INVENTION

For a better understanding of the technical solution of the invention, the invention is described in detail below in conjunction with accompanying drawings and specific embodiments.

### Embodiment 1

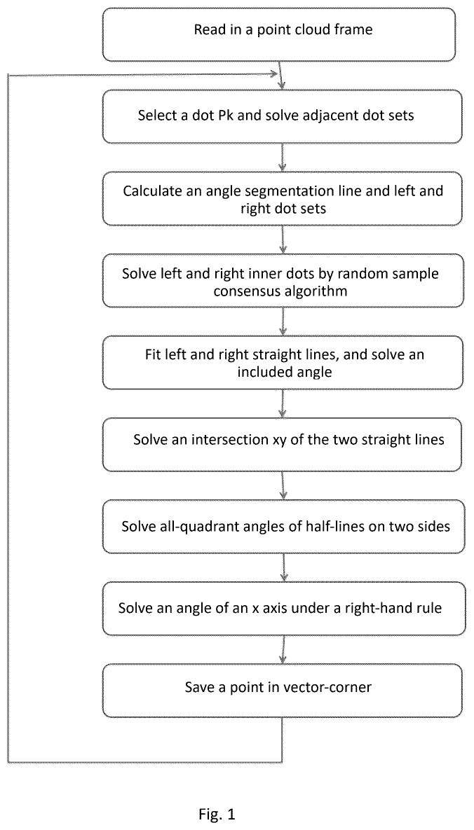

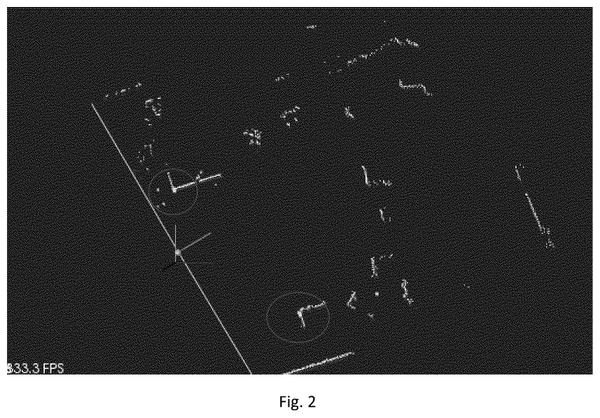

As shown in FIG. 1 and FIG. 2, a method for extracting the coordinates and angle of an environmental rectangular point based on two-dimensional lidar includes the following steps:

S100: laser dots in a natural environment point cloud frame scanned by a two-dimensional laser are traversed.

To be specific, a laser device is installed on an agv, the agv is driven to travel in the natural environment, two-dimensional scanning is performed by the laser device and a natural environment point cloud scanned by the laser device is input to laser mapping software to perform two-dimensional laser slam in real time, and all laser dots are traversed. To improve efficiency, in this embodiment, the step is set to 5, that is, calculation is performed every 5 of all the laser points.

S200: dot sets dots near in a neighborhood of a random dot Pk are selected, angles between lines from Pk as a starting dot to all other dots in dots near and an X axis of a laser coordinate system are calculated, and a mean value of all the angles is solved and used as an angle segmentation line of dots near.

To be specific, for the dot Pk selected in S100, dot sets dots near in the neighborhood of Pk are selected; if the number of the dot sets dots near is less than 20, the calculation fails, and the loop continues until the number of the dot sets dots near in the neighborhood of the dot Pk is greater than 20; then, with Pk as a starting dot, the angles between Pk and all other dots are calculated, and the mean value of all the angles is solved and used as the angle segmentation line of dots near.

Wherein, when the angles between Pk and all other dots in dots near are calculated, first, a laser coordinate system is created in the natural environment point cloud frame; then, Pk and other dots are connected to form a plurality of straight lines, and angles between the straight lines and the X axis are calculated; the angle segmentation line is not definitely one of all the lines, for example, if the mean value of all the angles is 40°, a 40° half-line is drawn with the X axis as a reference and used as the angle segmentation line; in addition, the diameter of the neighborhood may be selected according to the scale of the actual environment. In this embodiment, the diameter of the neighborhood is 0.5 m.

S300: dot sets dots left and dots right on left and right sides of dots near are separated according to the angle segmentation line, and inner dots inner left and inner right each having a variance less than a threshold are extracted from dots left and dots right by means of a straight line-based random sample consensus algorithm.

Wherein, if either the number of the dot sets dots left or the number of the dot sets dots right is less than 10, the calculation fails, and the loop continues; if either the number of the inner dots inner left or the number of the inner dots inner right is less than 10, the calculation fails, and the loop continues; and the threshold may be set according to the ranging accuracy of the laser.

S400: line left and line right are fitted according to the inner dots inner left and inner right by a straight line fitting method, an included angle between the two straight lines is solved, and when the included angle is close to 90°, an intersection of the two straight lines is determined as a rectangular point, and coordinates of the intersection of the two straight lines are determined and used as coordinates of the rectangular point.

To be specific, in this embodiment, when the included angle is between 80° and 100°, the intersection of the two straight lines is determined as the rectangular point.

S500, two half-lines coinciding with line left and line right are drawn with the rectangular point as a vertex, and an angle of the rectangular point is determined with one of the half-lines as a reference.

To be specific, the two half-lines are set as X₁ and Y₁ axes according to a right-hand rule, all-quadrant angles of the half-lines on two sides in the laser coordinate system are solved respectively, and an included angle between the X₁ axis and the X axis is used as the angle of the rectangular point.

S600: the rectangular point is saved in a vector vector corner; and if a distance and angle difference between a subsequent rectangular point Pm and any point in vector corner are within a threshold, the subsequent rectangular point Pm and the rectangular point are determined as a same point, and Pm is not saved in vector corner, that is to say, if a rectangular point solved later is approximate to the rectangular point solved previously to a certain extent, the rectangular point is determined as a repetitive point and is not saved.

The above embodiment is merely a preferred one of the invention. The protection scope of the invention is defined by the claims. Some improvements and embellishments made by those skilled in the art without departing from the spirit and scope of the invention should also fall within the protection scope of the invention.

What is claimed is:

1. A method for extracting the coordinates and angle of an environmental rectangular point based on two-dimensional lidar, comprising:
S100: traversing laser dots in a natural environment point cloud frame scanned by a two-dimensional laser;
S200: selecting dot sets dots near in a neighborhood of a random dot Pk, calculating angles between lines from Pk as a starting dot to all other dots in dots near and an X axis of a laser coordinate system, solving a mean value of all the angles, and using the mean value as an angle segmentation line of dots near;
S300: separating dot sets dots left and dots right on left and right sides of dots near according to the angle segmentation line, and extracting, from dots left and dots right, inner dots inner left and inner right each having a variance less than a threshold by means of a straight line-based random sample consensus algorithm;
S400: fitting line left and line right according to the inner dots inner left and inner right by a straight line fitting method, solving an included angle between the two straight lines, and when the included angle is close to 90°, determining an intersection of the two straight lines as a rectangular point; and
S500, drawing two half-lines coinciding with line left and line right with the rectangular point as a vertex, and determining an angle of the rectangular point with one of the half-lines as a reference.

2. The method for extracting the coordinates and angle of an environmental rectangular point based on two-dimensional lidar according to claim 1, wherein in S500, the two half-lines are set as X₁ and Y₁ axes according to a right-hand rule, wherein an included angle between the X₁ axis and the X axis as the angle of the rectangular point.

3. The method for extracting the coordinates and angle of an environmental rectangular point based on two-dimensional lidar according to claim 1, wherein in S200, the dot Pk is selected every five laser dots.

4. The method for extracting the coordinates and angle of an environmental rectangular point based on two-dimensional lidar according to claim 1, wherein the number of the dot sets dots near is greater than 20 and the number of the dot sets dots left and the number of the dot sets dots right are greater than 10; otherwise, the random dot Pk is reselected.

5. The method for extracting the coordinates and angle of an environmental rectangular point based on two-dimensional lidar according to claim 1, wherein the neighborhood has a diameter of 0.5 m.

6. The method for extracting the coordinates and angle of an environmental rectangular point based on two-dimensional lidar according to claim 1, wherein in S400, when the included angle is between 80° and 100°, the intersection of the two straight lines is determined as the rectangular point.

7. The method for extracting the coordinates and angle of an environmental rectangular point based on two-dimensional lidar according to claim 1, wherein S500 further comprises:
with the rectangular point as a center, respectively solving all-quadrant angles of the half-lines on two sides, and using an included angle between one of the half-lines and the X axis as the angle of the rectangular point.

8. The method for extracting the coordinates and angle of an environmental rectangular point based on two-dimensional lidar according to claim 1, further comprising:
S600: saving the rectangular point in a vector vector corner; and if a distance and angle difference between a subsequent rectangular point Pm and any point in vector corner are within a threshold, determining the subsequent rectangular point Pm and the rectangular point as a same point, and skipping saving Pm in vector corner.
